(19) United States
(12) Patent Application Publication
(10) Pub. No.: US 2005/0213745 A1
(43) Pub. Date: Sep. 29, 2005

(54) Voice activity detector for low S/N

(75) Inventor: Samuel L. Thomasson, Gilbert, AZ (US)

Correspondence Address: Paul F. Wille, 6407 East Clinton St., Scottsdale, AZ, 85254, US

(73) Assignee: Acoustic Technologies, Inc., Mesa, AZ (US)

(21) Appl. No.: 10/788,774

(22) Filed: Feb. 27, 2004

(51) Int. Cl. H04M 9/00

(52) U.S. Cl. 379/388.01

(57) ABSTRACT

Voice activity is detected by comparing an in band signal with an out of band signal. If the ratio of the signals is greater than a predetermined amount, then voice is detected.

### BACKGROUND OF THE INVENTION

This invention relates to a voice activity detector and, in particular, to a circuit that provides a stable indication of voice activity for use in telephones, particularly in speaker phones, and in other applications wherein the signal to noise ratio is less than one (i.e. the amplitude of the noise is greater than the amplitude of the signal).

As used herein, “telephone” is a generic term for a communication device that utilizes, directly or indirectly, a dial tone from a licensed service provider. As such, “telephone” includes desk telephones, cordless telephones, speaker phones (see FIG. 1), hands free kits, and cellular telephones, among others. For the sake of simplicity, the invention is described in the context of telephones but has broader utility; e.g. communication devices that do not utilize a dial tone, such as radio frequency transceivers.

Anyone who has used current models of speaker phones is well aware of the cut off speech and the silent periods during a conversation caused by echo canceling circuitry within the speaker phone. Such phones operate in what is known as half-duplex mode, which means that either the receive channel or the transmit channel is at minimum gain or “off” and only one person can speak and be heard. While such silent periods assure that sound from a speaker is not coupled directly into a microphone within a speaker phone, the quality of the call is poor. It is preferred to operate in full duplex mode wherein the gain in the transmit channel and the gain in the receive channel may not be equal but are set above a minimum hearing level.

Another problem with speaker phones and hands free kits is that the speaker element may be located near the microphone. In such cases, the sound emanating from the speaker element can be quite loud compared with the sound of a person's voice in the same room or the same vehicle. Noise is somewhat like a weed, it is relative. It depends upon what one wants or does not want. In this description, noise is unwanted sound from the perspective of the operation of the telephone. For example, in a vehicle, noise includes road noise, music from a radio, background conversation, and the sound from the speaker element in a hands free kit. The (desired) signal is the voice of the person speaking into the microphone of the hands free kit. A similar definition applies to speaker phones. Thus defined, the signal (voice) to noise ratio of the sound impinging on a microphone can be less than one.

Detecting a voice signal is difficult even when the signal to noise ratio is substantially greater than one. A great many sophisticated circuits have been proposed and even used with various degrees of success. All known systems rely on analyzing a signal to look for traits characteristic of a voice. For example, U.S. Pat. No. 5,598,466 (Graumann) discloses a voice activity detector including an algorithm for distinguishing voice from background noise based upon an analysis of average peak value of a voice signal compared to the current value of the audio signal.

Typically, these systems are implemented in digital form and manipulate large amounts of data in analyzing the input signals. An extensive computational analysis to determine relative power takes too long. All these systems manipulate amplitude data, or data derived from amplitude, up to the point of making a binary value signal indicating voice.

Voice detection is not just used to determine whether to transmit or receive. A reliable voice detection circuit is necessary in order to properly control echo canceling circuitry, which, if activated at the wrong time, can severely distort a desired voice signal. In the prior art, this problem has not been solved satisfactorily.

In view of the foregoing, it is therefore an object of the invention to provide a simplified but accurate voice activity detector.

Another object of the invention is to provide a voice activity detector that is particularly well suited to detecting voice when the signal to noise ratio is near or even less than one.

A further object of the invention is to improve full duplex operation in a speaker phone.

Another object of the invention is to improve echo cancellation in a telephone.

### SUMMARY OF THE INVENTION

The foregoing objects are achieved in this invention in which voice activity is detected by comparing an in band signal with an out of band signal. If the ratio of the signals is greater than a predetermined amount, then voice is detected.

### BRIEF DESCRIPTION OF THE DRAWINGS

A more complete understanding of the invention can be obtained by considering the following detailed description in conjunction with the accompanying drawings, in which:

FIG. 1 is a perspective view of a conference phone or a speaker phone;

FIG. 2 is a generic block diagram of audio processing circuitry in a telephone;

FIG. 3 is a more detailed block diagram of audio processing circuitry in a telephone;

FIG. 4 is a block diagram of a voice activity detector constructed in accordance with the invention;

FIG. 5 is a chart explaining the operation of the circuit in FIG. 4; and

FIG. 6 is a chart illustrating operation in accordance with an alternative embodiment of the invention.

Those of skill in the art recognize that, once an analog signal is converted to digital form, all subsequent operations can take place in one or more suitably programmed microprocessors. Reference to “signal”, for example, does not necessarily mean a hardware implementation or an analog signal. Data in memory, even a single bit, can be a signal. In other words, a block diagram herein can be interpreted as hardware, software, e.g. a flow chart, or a mixture of hardware and software. Programming a microprocessor is well within the ability of those of ordinary skill in the art, either individually or in groups.

### DETAILED DESCRIPTION OF THE INVENTION

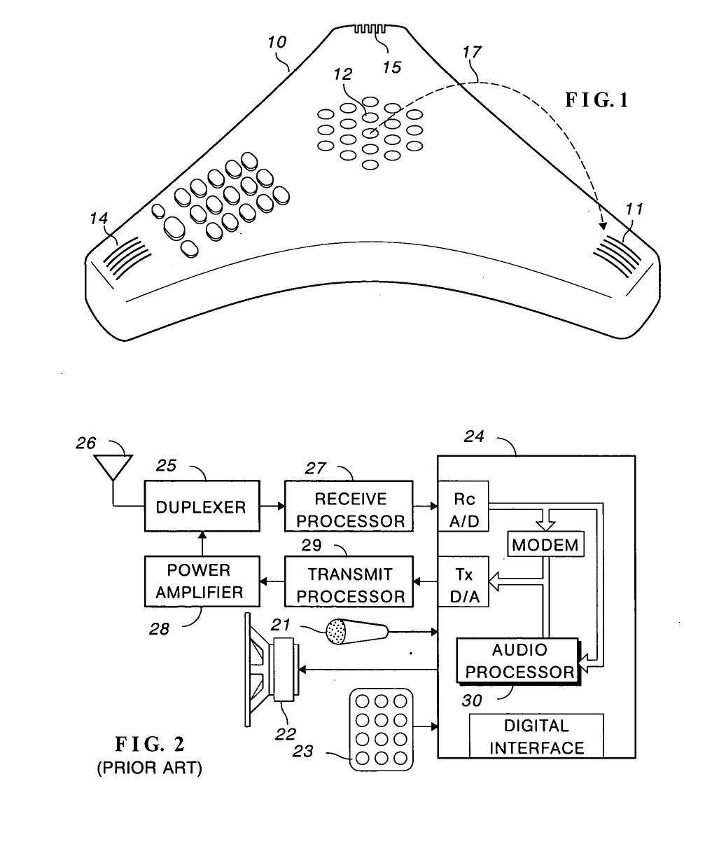

FIG. 1 illustrates a conference phone or speaker phone such as found in business offices. Telephone 10 includes microphone 11 and speaker 12 in a sculptured case. Telephone 10 may include several microphones, such as microphones 14 and 15 to improve voice reception or to provide several inputs for echo rejection or noise rejection, as disclosed in U.S. Pat. No. 5,138,651 (Sudo).

As indicated by dashed line 17, there is or can be significant acoustic coupling between speaker 12 and microphone 11, and other microphones if present. Further, the coupling can be internal or external to speaker phone 10. As such, it is not only possible but likely that the signal to noise ratio of the sound striking microphone 11 is nearly one or even less than one.

The various forms of telephone can all benefit from the invention. FIG. 2 is a block diagram of the major components of a cellular telephone. Typically, the blocks correspond to integrated circuits implementing the indicated function. Microphone 21, speaker 22, and keypad 23 are coupled to signal processing circuit 24. Circuit 24 performs a plurality of functions and is known by several names in the art, differing by manufacturer. For example, Infineon calls circuit 24 a “single chip baseband IC.” QualComm calls circuit 24 a “mobile station modem.” The circuits from different manufacturers obviously differ in detail but, in general, the indicated functions are included.

A cellular telephone includes both audio frequency and radio frequency circuits. Duplexer 25 couples antenna 26 to receive processor 27. Duplexer 25 couples antenna 26 to power amplifier 28 and isolates receive processor 27 from the power amplifier during transmission. Transmit processor 29 modulates a radio frequency signal with an audio signal from circuit 24. In non-cellular applications, such as speakerphones, there are no radio frequency circuits and signal processor 24 may be simplified somewhat. Problems of echo cancellation and noise remain and are handled in audio processor 30. It is audio processor 30 that is modified to include the invention. How that modification takes place is more easily understood by considering the echo canceling and noise reduction portions of an audio processor in more detail.

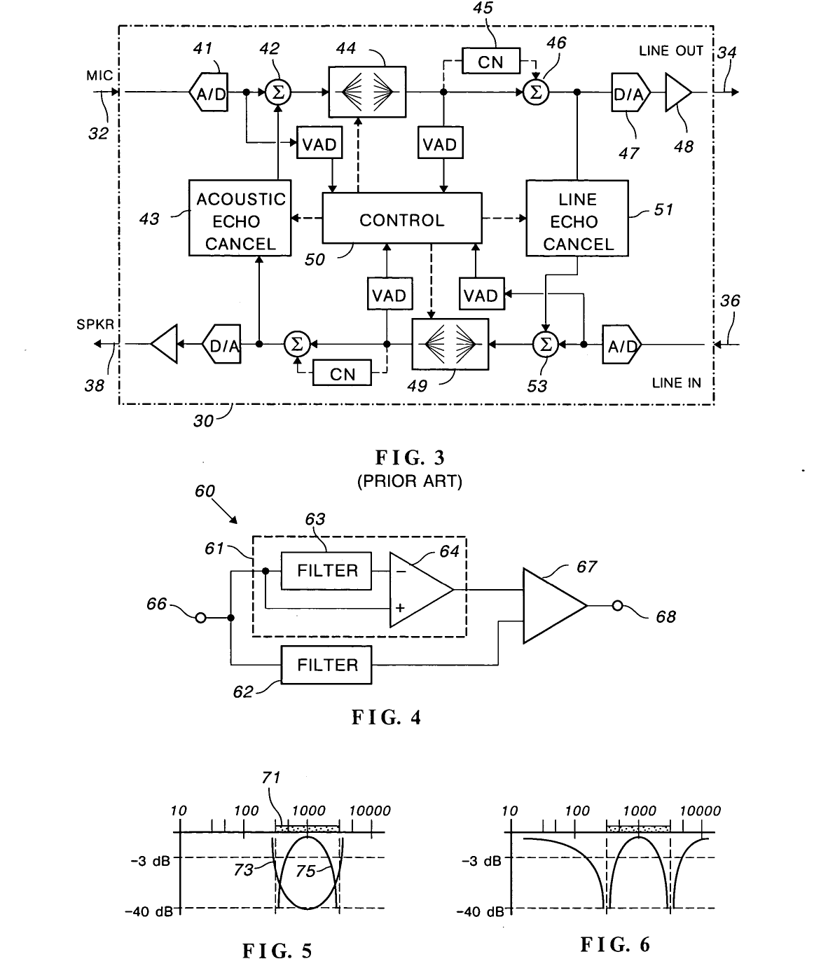

FIG. 3 is a detailed block diagram of a noise reduction and echo canceling circuit; e.g. see chapter 6 of Digital Signal Processing in Telecommunications by Shenoi, Prentice-Hall, 1995, with the addition of four VAD circuits and the addition of sub-band filter banks. The following describes signal flow through the transmit channel, from microphone input 32 to line output 34. The receive channel, from line input 36 to speaker output 38, works in the same way.

A new voice signal entering microphone input 32 may or may not be accompanied by a signal from speaker output 38. The signals from input 32 are digitized in A/D converter 41 and coupled to summation circuit 42. There is, as yet, no signal from echo canceling circuit 43 and the data proceeds to sub-band filters 44, which are initially set to minimum attenuation.

The output from sub-band filters 44 is coupled to summation circuit 46, where comfort noise 45 is optionally added to the signal. The signal is then converted back to analog form by D/A converter 47, amplified in amplifier 48, and coupled to line output 34. Data from the four VAD circuits is supplied to control 50, which uses the data for allocating sub-bands, echo elimination, double talk detection, and other functions. Circuit 43 reduces acoustic echo and circuit 51 reduces line echo. The operation of these last two circuits is known per se in the art.

Noise is rarely if ever purely random but it does have a relatively uniform amplitude across a broad spectrum. Even music or other man made sound has a spectrum that is wider than the voice band of a telephone and this difference in bandwidth is exploited by the invention to detect voice.

FIG. 4 is a block diagram of a voice activity detector constructed in accordance with a preferred embodiment of the invention. VAD 60 includes band reject filter 61 and band pass filter 62 having substantially the same center frequency but not the same roll-off characteristics. FIG. 5 is a chart of frequency versus amplitude. Voice band 71 of a telephone system (300 Hz to 3000 Hz) is represented by a stippled rectangle. The frequency response of band reject filter 61 is represented by curve 73. The frequency response of band pass filter 62 is represented by curve 75. Curve 73 and curve 75 intersect below −3 dB and, preferably, intersect below −30 dB. In addition, curve 75 does not extend beyond the boundaries of the telephone bandwidth above −40 dB. Curve 73 preferably is within the 300/3000 boundaries at −3 dB and less. It is understood that these figures are not intended with mathematical precision but within a tolerance determined by what can be achieved realistically with known circuits, preferably circuits that can be implemented in integrated circuit form. Some people list the frequency response or voice band of a telephone as 300-2800 Hz. It is known in the art how to control the shape of the frequency response curve with relatively simple circuits; see U.S. Pat. No. 6,492,865 (Thomasson). Suitable filters can also be implemented digitally as IIR (Infinite Impulse Response) filters or other technologies, as noted in the patent. While the frequency response curves may not be ideal or exactly 300 to 3000 Hz, the goal is to compare energy within a band with energy outside substantially the same the band and come to a decision about whether or not there is a voice signal.

A band reject filter is most easily implemented as a band pass filter combined with a difference amplifier, as shown in FIG. 4. Band reject filter 61 includes band pass filter 63 coupled to an inverting input of amplifier 64. The signal on input 66 is coupled to a non-inverting input of amplifier 64. As described above, the response of filter 61 is represented by curve 75 (FIG. 5). The filters are configured to provide a slight separation in response at the band boundaries. This is preferred because it reduces the possibility of false positive indications of voice.

In operation, a voice signal adds energy content to the output from filter 62 (FIG. 4) but not to the output from filter 61, even at signal to noise levels below one. The imbalance is detected by comparator 67, which produces a signal on output 68 indicative of voice. In the absence of voice, the signals from filters 61 and 62 are approximately the same. In actual operation, because voice (background conversations) may be part of the noise, comparator 67 is adjustably biased to provide an output signal indicating no voice unless the signal from filter 62 exceeds the signal from filter 61 by a predetermined amount. Detection can be further enhanced, although slowed slightly, by averaging the outputs from the filters prior to comparison.

FIG. 6 illustrates an alternative implementation of the invention wherein three filters are used; a low pass filter, a band pass filter, and a high pass filter, having the frequency responses shown in the figure. The outputs of the low pass filter and the high pass filter are added and compared with the output of the band pass filter. Again, a slight separation in response at the boundaries is preferred.

The invention thus provides a simplified but accurate voice activity detector that is particularly well suited to detecting voice when the signal to noise ratio is near or even less than one. By being able to detect voice under low S/N conditions, one can improve full duplex operation in a speaker phone and improve echo cancellation in a telephone.

Having thus described the invention, it will be apparent to those of skill in the art that various modifications can be made within the scope of the invention. For example, in a circuit implementing FIG. 6, the high pass filter can be eliminated. Depending upon implementation, “amplitude” means either magnitude or energy. In some audio processing systems, in band energy data or in band magnitude data may exist for other purposes, e.g. data from sub-band filter 44 or sub-band filter 49 (FIG. 3). Thus, one need only generate data representing out of band energy or magnitude to implement the invention.

1. A telephone characterized by a voice activity detector comprising:
a band reject filter having an input and an output;
a first band pass filter having an input and an output;
a comparator coupled to the output of the band reject filter and the band pass filter.

2. The telephone as set forth in claim 1 wherein said band reject filter includes:
a second band pass filter having an input coupled to the input of said band reject filter and an output;
an amplifier having an inverting input coupled to the output of the band pass filter, a non-inverting input coupled to the input of said band reject filter, and an output coupled to said comparator.

3. The telephone as set forth in claim 1 wherein the center frequency of the band pass filter and the center frequency of the band reject filter are substantially the same.

4. The telephone as set forth in claim 1 wherein the frequency response of the band reject filter is slightly broader than the frequency response of the band pass filter.

5. The telephone as set forth in claim 1 wherein the band reject filter includes a low pass filter having a cut-off frequency below the center frequency of the band pass filter.

6. The telephone as set forth in claim 5 wherein the band reject filter further includes a high pass filter having a cut-off frequency above the center frequency of the band pass filter.

7. A method for detecting voice in a telephone having a predetermined voice band, said method comprising the steps of:
comparing the amplitude of a first signal within the voice band with a second signal outside the voice band;
providing a first output when the ratio of the first signal to the second signal is below a predetermined value; and
providing a second output when the ratio of the first signal to the second signal is above the predetermined value, wherein one of the first output and the second output indicates the presence of a voice signal.

8. The method as set forth in claim 7 and including the step of:
adjusting the ratio to favor an indication of the absence of a voice signal.
